(19) United States
(12) Patent Application Publication
(10) Pub. No.: US 2007/0086068 A1
(43) Pub. Date: Apr. 19, 2007

(54) Image processing apparatus

(76) Inventors: Satoshi Ohkawa, Tokyo (JP); Manabu Komatsu, Tokyo (JP); Hiroyuki Kawamoto, Kanagawa (JP); Tomoyuki Yoshida, Tokyo (JP); Toshiya Hikita, Tokyo (JP); Toshimi Yamamura, Kanagawa (JP); Atsushi Togami, Kanagawa (JP); Shuji Kimura, Kanagawa (JP); Takumi Nozawa, Kanagawa (JP); Yasunobu Shirata, Tokyo (JP); Akira Murakata, Tokyo (JP); Yukihiko Tamura, Kanagawa (JP)

Correspondence Address: HARNESS, DICKEY & PIERCE, P.L.C., P.O. BOX 8910, RESTON, VA, 20195, US

(21) Appl. No.: 11/546,353

(22) Filed: Oct. 12, 2006

(30) Foreign Application Priority Data
Oct. 18, 2005 (JP) 2005-303291

(51) Int. Cl. H04N 1/04

(52) U.S. Cl. 358/500; 358/474

(57) ABSTRACT

An image processing apparatus includes an image scan unit configured to scan a document to produce electronic image data, a check unit configured to make determination as to whether the document is a color document or a monochrome document based on the image data scanned by the image scan unit, a scan image correction unit configured to correct the image data scanned by the image scan unit such that the image data has predetermined data characteristics, a memory unit configured to store the image data corrected by the scan image correction unit, and an image processing unit configured to perform image processing on the image data stored in the memory unit in response to the determination made by the check unit and characteristics required for outputting of the image data.

### BACKGROUND OF THE INVENTION

1. Field of the Invention

The present invention generally relates to image processing apparatuses, and particularly relates to an image processing apparatus having the function to properly process an image scanned from a document.

2. Description of the Related Art

Owing to the development of laser-based writing apparatuses and CCD (Charge Coupled Device)—based line-sensor scan apparatuses, digital copiers, as opposed to conventional analog copiers, are now available that process digitized image data.

Digital copiers have developed into a configuration that controls multi-functions by including a scanner function, a printer function, and a facsimile function in addition to a copy function, which are referred to as a digital MFP (multi-function printer).

MFPs may be connected to a network, and store output data in an embedded HDD (hard-disk drive) or the like, so that the image data stored in the HDD may be transferred through the network.

The usage of MFPs in the office environment has been becoming diversified. For example, a small-size MPF may be installed beside and associated with a PC (personal computer), so that each office worker can have an easy access to the copier, facsimile, printer, and scanner functions. Further, a middle-size MFP may be shared by a group of people on a division basis or on a section basis, and may be capable of providing satisfactory productivity and various functions such as sorting, punching, stapling, etc. A large-size MPF that provides high productivity, high performance, and sophisticated functions may be used in a division that mainly performs copy-related tasks in the company, or may be used in a company whose main business is copy-related tasks.

In this manner, MFPs are diversified into small-size through large-size MFPs. While there are functions that are provided in common across all the classes, there are some functions that may mainly be required for a particular class. For example, a large-size MFP may be required to be capable of post-processing functions such as punching, stapling, and paper-holding that are applied to printed paper sheets, and may also be required to be capable of electronic data filing in conjunction with copy tasks. Further, a small-size MFP may be required to have an internet-FAX function, PC-FAX function, etc., and may also be required to be capable of high-quality image printing with respect to dedicated paper sheets for personal-use purposes. In the market for such diversified MFPs, MFPs which are configured to include a set of functions necessary for their classes have conventionally been provided and soled.

The importance of information in business is widely recognized, so that it is required not only to convey information in a fast, accurate, and reliable manner, but also to convey information in an effective manner that is easy to understand. Together with the increased performance and promulgation of the communication technology, the capacity increase, cost reduction, size reduction of memory devices, the increased performance of PCs, etc., new functions for effectively treating information by use of digital data are now available. It is desired for MFPs that handle digital image data, which is one type of digital data, to be equipped with such new functions.

Patent Document 1 is directed to an image processing apparatus and image outputting method that control multi-functions such as a copy function, a scanner function, a printer function, and facsimile function, and discloses a technology which attains optimum image quality by eliminating trouble associated with scanning and degradation in document quality and also by improving the releasing of a document. Patent Document 2 discloses an input/output apparatus that transfers or prints, to a specified destination, input data or data supplied from a communication line having a different transfer method. Patent Document 3 discloses a technology that converts the color space specific to a scanner into a standard color space, and that converts the standard color space into a color space specific to the printer. Patent Document 4 is directed to an image processing apparatus, image scan apparatus, image forming apparatus, and copier apparatus that are used to form an image in color digital copiers, color printers, facsimile devices, etc., and discloses an image processing apparatus, image scan apparatus, image forming apparatus, and copier apparatus that determine whether a document is a color document or a black-and-white document based on the image data scanned from the document.

Patent Document 1

Japanese Patent Application Publication No. 2001-223828

Patent Document 2

Japanese Patent Application Publication No. 2001-251522

Patent Document 3

Japanese Patent Application Publication No. 6-054176

Patent Document 4

Japanese Patent Application Publication No. 2004-112725

The outputs of MFPs may be presented on paper sheets as in the case of copying described above, and may also be transmitted as electronic data as in the case of scanner or FAX transmission. The output format differs depending on its usage even in the case of electronic data transmission. For example, FAX may use an image data format based on monochrome binary values while scanners may use color RGB (red, green, blue) image data.

MFPs output image data through various output mechanisms, and these output mechanisms have their own output characteristics that are different from each other. In the case of paper output, the writing unit has its own characteristics. In the case of image delivery from a scanner, the display unit for presenting an image has its own characteristics.

Some MFPs are provided with the function to determine whether a scanned document is a color document or a monochrome document and to perform the monochrome outputting for a monochrome document and the color outputting for a color document.

In such MFPs, a pre-scan is performed to determine whether a scanned document is a color document or a monochrome document, and another scan is thereafter performed to perform processing in accordance with the determination made for the document. In such a configuration, documents need to be scanned twice. If there are two or more document sheets, and the document feeder of the scan unit comes to a halt due to paper jam or the like, a problem may arise in that a match is lost between the determination made for each document sheet and the counting of scanned sheets. There is another problem in that it takes twice as much time due to the scanning of each document sheet twice.

There is a configuration that simultaneously generates a color image and a monochrome image at the time of scanning a document without performing a pre-scan. When generating a copy, however, a CMYK (cyan, magenta, yellow, black) image is generated first, followed by using the K signal only to generate an image if the determination indicates a monochrome document, and by using the CMYK signals to generate an image if the determination indicates a color document. Since the CMYK data generated in this case is configured such that the monochrome image data based on the K signal alone suffices, there is degradation in the image quality unlike in the case of image data that is prepared through image processing specialized for color documents or specialized for monochrome documents. In such a configuration, further, when the image data is to be transmitted to a PC or the like, a color image needs to be generated as a RGB image, and a monochrome image needs to be generated as a K image. This gives rise to a problem in that two types of images need to be generated simultaneously.

Accordingly, there is a need for an image processing apparatus that can both make a determination and obtain the image data of a document through a single scan, and that can apply optimum image processing based on the determination.

### SUMMARY OF THE INVENTION

It is a general object of the present invention to provide an image processing apparatus that substantially obviates one or more problems caused by the limitations and disadvantages of the related art.

Features and advantages of the present invention will be presented in the description which follows, and in part will become apparent from the description and the accompanying drawings, or may be learned by practice of the invention according to the teachings provided in the description. Objects as well as other features and advantages of the present invention will be realized and attained by an image processing apparatus particularly pointed out in the specification in such full, clear, concise, and exact terms as to -enable a person having ordinary skill in the art to practice the invention.

To achieve these and other advantages in accordance with the purpose of the invention, the invention provides an image processing apparatus includes an image scan unit configured to scan a document to produce electronic image data, a check unit configured to make determination as to whether the document is a color document or a monochrome document based on the image data scanned by the image scan unit, a scan image correction unit configured to correct the image data scanned by the image scan unit such that the image data has predetermined data characteristics, a memory unit configured to store the image data corrected by the scan image correction unit, and an image processing unit configured to perform image processing on the image data stored in the memory unit in response to the determination made by the check unit and characteristics required for outputting of the image data.

According to another aspect of the present invention, a method for image processing includes an image scan step of scanning a document to produce electronic image data, a check step of making determination as to whether the document is a color document or a monochrome document based on the image data scanned by the image scan step, a scan image correction step of correcting the image data scanned by the image scan step such that the image data has predetermined data characteristics, a storing step of storing the image data corrected by the scan image correction step, and an image processing step of performing image processing on the image data stored by the storing step in response to the determination made by the check step and characteristics required for outputting of the image data.

According to at least one embodiment of the present invention, provision is made to both make a determination and obtain the image data of a document through a single scan, and to apply optimum image processing based on the determination.

### BRIEF DESCRIPTION OF THE DRAWINGS

Other objects and further features of the present invention will be apparent from the following detailed description when read in conjunction with the accompanying drawings, in which:

FIG. 1 is a drawing showing an example of the configuration of a digital copier according to an embodiment of the present invention;

FIG. 2 is a flowchart showing an example of processing performed by the digital copier;

FIG. 3 is a drawing showing an example of processing performed by the scan image correction unit;

FIG. 4 is a drawing showing an example of processing performed by the image processing unit; and

FIG. 5 is a drawing showing an example of image data delivery.

### DESCRIPTION OF THE PREFERRED EMBODIMENTS

In the following, embodiments of the present invention will be described with reference to the accompanying drawings.

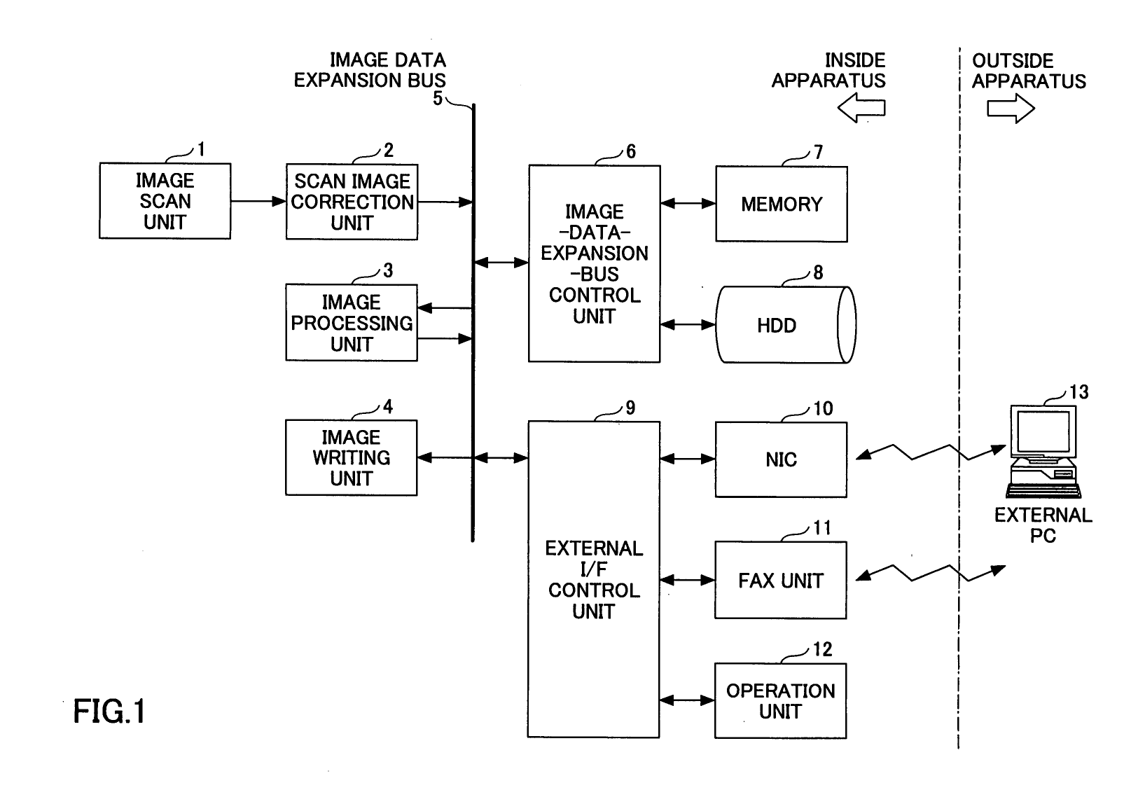

FIG. 1 is a drawing showing an example of the configuration of a digital copier according to an embodiment of the present invention. This digital copier is an embodiment of the image processing apparatus of the present invention, and is a multi-function printer (multifunctional peripheral).

In FIG. 1, the digital copier includes an image scan unit 1 (provided with a line sensor comprised of a CCD photoelectrical conversion device, an A/D converter, and relevant drive circuits) for scanning an image from a document to obtain electronic image data, a scan image correction unit 2 for correcting the scanned image data into predetermined data characteristics, an image processing unit 3 for applying image processing on the image data stored in the copier in accordance with output characteristics, and an image writing unit 4 for plotting an image on a paper sheet or the like. The scan-image correcting unit 2, image processing unit 3, and image writing unit 4 are connected to an image data expansion bus 5. The image data expansion bus 5 is also connected to a memory 7 and an HDD 8 via an image-data-expansion-bus control unit 6, thereby making it possible to store image data on a temporal basis and on a permanent basis. Further, the image data expansion bus 5 is connected via an external I/F control unit 9 to an NIC 10 for communicating with an external PC 13 or the like, a FAX unit 11 for FAX communication, and an operation unit 12 that is operated by a user.

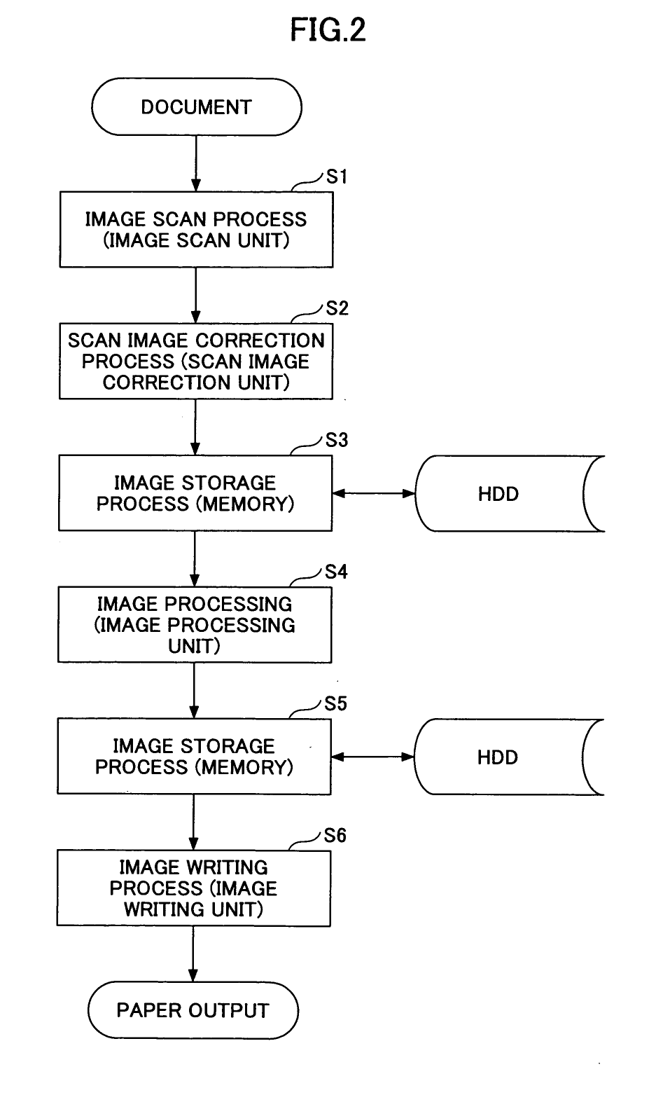

FIG. 2 is a flowchart showing an example of processing performed by the digital copier of FIG. 1. FIG. 2 illustrates a series of processes performed from the scanning of a document to the outputting of a printout when copying the document.

In FIG. 2, the image scan unit 1 scans an image from a document (step S1). Namely, the image scan unit 1 scans a document that is set in place, and produces digital image data having RGB components each comprised of 8 bits representing the tones of the document. The scanned image data is supplied to the scan image correction unit 2.

The scan image correction unit 2 determines attributes inclusive of whether the document is a color document or a monochrome document based on the scanned image data, and corrects the scanned image data into predetermined data characteristics (step S2).

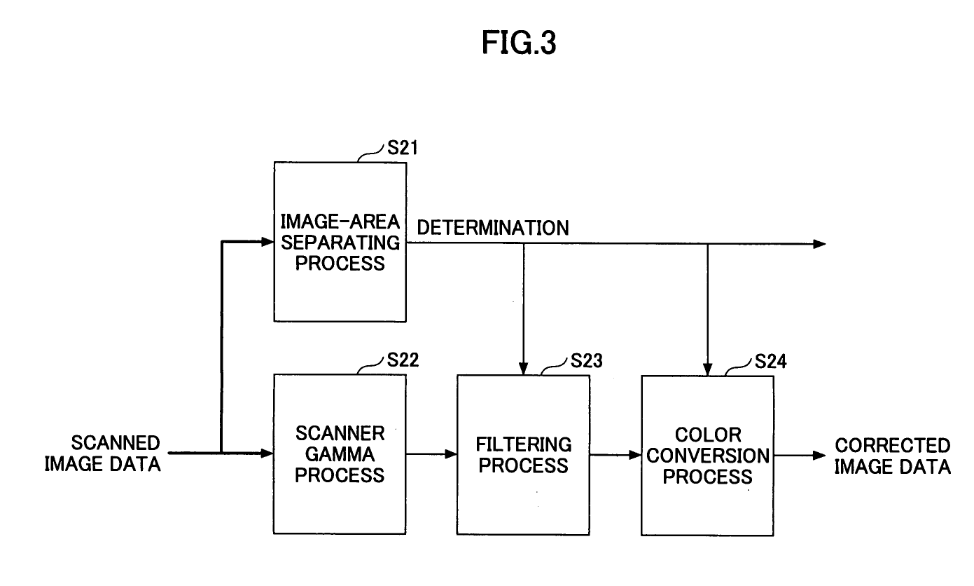

FIG. 3 is a drawing showing an example of processing performed by the scan image correction unit 2. In FIG. 3, the scan image correction unit 2 performs an image-area separating process on the image data (scanned image data) scanned by the image scan unit 1 (step S21). This image-area separating process includes the extraction of characteristic areas contained in the document. For example, screen-dot portions made by a typical printing process and the edge portions of letters may be extracted. Further, determination as to whether the image data is chromatic (color) or monochrome and determination as to whether the background image is white may be made, followed by outputting the determinations thus made. In this manner, the image-area separating process (step S21) includes not only the determining of characteristic areas in the document but also the determining of characteristics of the document itself. The image-area separating process includes the mechanism to determine whether a document is a color document or a black-and-white document as described in Patent Document 4. These determinations are stored as bibliographic information about the image data together with the image data when the image data processed by the scan image correction unit 2 is stored in the memory 7 or the HDD 8 as will later be described. The stored determinations are utilized when the image processing unit 3 performs an outputting process. If the scanned document is determined as a color document, for example, image processing for outputting of a color image is performed. If the scanned document is determined as a black-and-white document, the image processing unit 3 performs the process to convert the RGB color image into a monochrome output image.

Further, a scanner gamma process is performed with respect to the image data (scanned image data) scanned by the image scan unit 1 (step S22). This scanner gamma process performs an image gamma conversion that converts the gamma characteristic of the image scan unit 1 into a standard characteristic.

Thereafter, a filtering process is performed with respect to the image data on which the scanner gamma process has been performed (step S23). The filtering process serves to transform the spatial frequencies of the image data. Further, the filtering process performs characteristic filtering on the extracted areas by use of the determinations made by the image-area separating process (step S21). In the areas that are determined as screen-dot areas, for example, a smoothing process is performed to smooth the screen dots. If there is an edge portion having a white background, an edge enhancement process is performed such as to improve the MFT (modulation transfer function) characteristics based on the estimation that the area of interest is a letter area.

Thereafter, a color-conversion process is performed with respect to the image data on which the filtering process has been performed (step S24). This color conversion process performs a color conversion matching the output characteristics. For example, a RGB conversion into universally-applicable RGB data or into a predetermined color space is performed.

By turning back to FIG. 2, an image storage process (step S3) is performed with respect to the image data on which the scanned-image-correction process (step S2) has been performed. Namely, the image data is stored in the memory 7 and also in the HDD 8 according to need. In so doing, the determinations made by the image-area separating process (step S21) are also simultaneously stored together with the image data. When the image data scanned by the line scanner of the image scan unit 1 is to be transferred to the image processing unit 3 via the scan image correction unit 2, the memory 7 stores the image data if the image processing unit 3 is engaged in another processing while the image scan unit 1 is engaged in the scanning. The HDD 8 mainly serves to obviate the problem of overflow of the memory 7. There would not be any problem if the image data could be transferred to the image writing unit 4 such as a plotter at the same timing as the document is scanned by the image scan unit 1. However, a situation may arise in which the image data cannot be output due to the ongoing preparation of an outputting process while the image data is being input, resulting in an overflow of the memory 7. Provision of sufficient memory space in the memory 7 may solve the problem, but results in an increase of the hardware cost. In consideration of this, the HDD 8 having a large capacity is used to temporarily store the image data, thereby obviating the problem of overflow of the memory 7. The image data expansion bus 5 is shared by each module, and is controlled by the image-data-expansion-bus control unit 6 provided for the purpose of controlling the inputs/outputs thereof. The memory 7 such as a RAM serving as a memory medium and the HDD 8 are connected to the image-data-expansion-bus control unit 6, and are controlled as appropriate.

Thereafter, the image processing unit 3 performs image processing (step S4) with respect to the image data on which the image storage process (step S3) has been performed. Namely, the image processing unit 3 receives the image data from the memory 7, and converts the characteristics of the stored image data into the characteristics of image data to be output onto a paper sheet, e.g., into a CMYK image if the outputting device is a color writing apparatus.

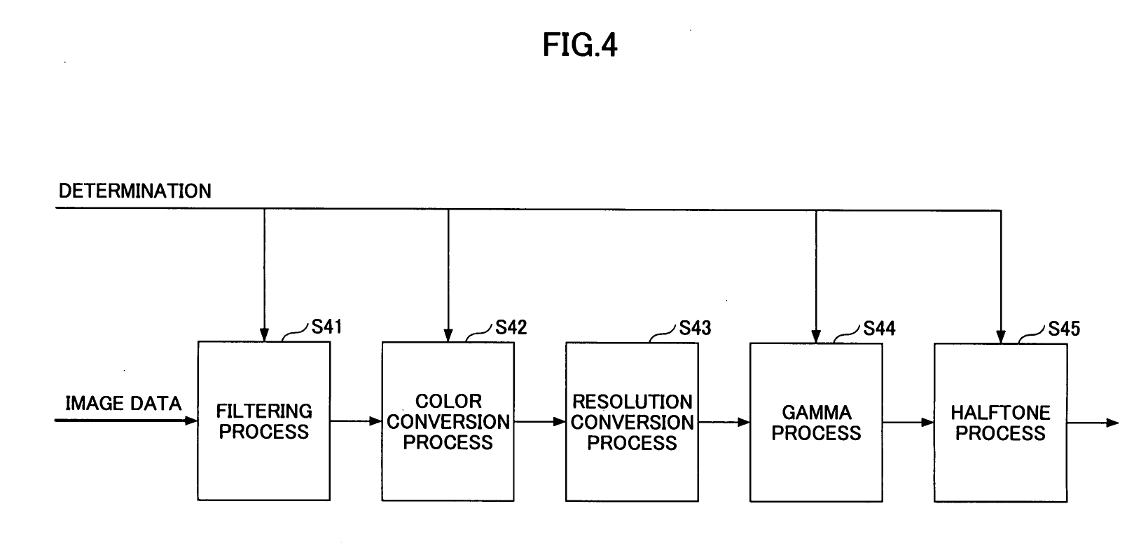

FIG. 4 is a drawing showing an example of processing performed by the image processing unit 3. In FIG. 4, the input data includes the image data and the data indicative of the determinations made by the image-area separating process (step S21). The image processing unit 3 performs filtering (step S41) in response to the determinations such as to match the MTF characteristics of the image writing unit 4. The filtering process (step S23) performed by the scan image correction unit 2 previously described serves to perform a conversion into predetermined characteristics for storage in the memory 7 and/or HDD 8. On the other hand, the filtering process (step S41) serves to perform a conversion from the predetermined storage image characteristics into the image characteristics of the image writing unit 4. Further, a conversion responsive to characteristics is performed by use of the determinations indicative of the characteristics of the document.

Thereafter, a color-conversion process (step S42) is performed with respect to the image data on which the filtering process (step S41) has been performed. The determinations made by the image-area separating process are used to estimate that a letter of interest is a black letter if monochrome is indicated, for example, so that the black-single-color processing (i.e., conversion from RGB to K) is performed during the CMYK conversion based on such estimation. For other processes also, processing can be performed by use of optimum parameters provided for the monochrome image. In this manner, even through a color scan is performed, the generation of a monochrome image is properly done at the time of outputting when the document is determined as a monochrome image.

Thereafter, a resolution conversion process (step S43) for the purpose of performing a desired resizing process is performed with respect to the image data on which the color conversion process (step S43) has been performed.

Thereafter, a gamma process (step S44) for performing a gamma conversion from the predetermined storage image characteristics into the output characteristics is performed with respect to the image data on which the resolution conversion process (step S43) has been performed.

A halftone process (step S45) that conforms to the characteristics of the image writing unit 4 is performed with respect to the image data on which the gamma process (step S44) has been performed. For example, dither processing and error-diffusion processing may be performed. Further, a conversion into the depth (i.e., number of bits) of the gray scale of the image writing unit 4 is performed. If the output is represented by use of 1 bit, for example, 8-bit signals supplied as the input are subjected to dither processing so as to be converted into 1-bit signals.

The processing of the image processing unit 3 described above is performed when the copier function is set to select a color/monochrome determination as a default setting, or when the user desires an output made by use of a color/monochrome determination. Needless to say, the outputting of a printout as a color image or a monochrome image, whichever is desired, without regard to the determination is also possible. In such a case, the processes included in the image processing unit 3 are performed such as to achieve respective, desired image characteristics.

By turning back to FIG. 2, an image storage process (step S5) is performed with respect to the image data on which the image processing (step S4) has been performed. Namely, the image data is stored in the memory 7 and also in the HDD 8 according to need. When the image data processed by the image processing unit 3 is to be transferred to the image writing unit 4, the memory 7 stores the image data if the transfer speed does not match the processing speed, e.g., if the transfer speed does not match the timing of the processing by the image writing unit 4 during the ongoing image processing by the image processing unit 3. The HDD 8 mainly serves to obviate the problem of overflow of the memory 7. The transfer of data from the image processing unit 3 to the image writing unit 4 is performed via the image data expansion bus 5. Depending on the control timing, the preparation for outputting to paper in the engine plotter may not yet be ready when an attempt is made to output the image data processed by the image processing unit 3 to the image writing unit 4. In such a case, the image data is temporarily stored in the HDD 8 via the memory 7.

Thereafter, the image writing unit 4 performs an image writing process (step S6) with respect to the image data on which the image storage process (step S5) has been performed. Namely, upon receipt of the CMYK digital image data, the image writing unit 4 outputs the received image data onto a paper sheet by use of an electrophotography process utilizing a laser beam.

In connection with the flowchart of FIG. 2 described above, a description has been given with respect to an example of a copy process in which printing to a paper sheet is performed in conjunction with the scanning of the document. Alternatively, the image data scanned from the document may be stored in such a format that is device-independent for subsequent use. In such a case, the flow of the processes has a discontinuity between the image storage process (step S3) and the image processing (step S4) in FIG. 2. Prior to the discontinuity, the scan image correction unit 2 converts image data into such a format that is device-independent in the scan image correction process (step S2) after the image scan unit 1 such as a scanner generates the image data from a document in the image scan process (step S1). As an example of the characteristics of the image data that is device-independent, a color space may be a standard color space such as an sYCC color space or an AdobeRGB space, or may be a predetermined RGB space. The spatial frequencies may also be determined. The scan image correction unit 2 performs the conversions to achieve such characteristics. The post-correction image data is then stored in the HDD 8 via the image data expansion bus 5 (step S3).

The condition for making a color/monochrome determination in the image-area separating process (step S21) by the scan image correction unit 2 may be set such that the determinations are produced regardless of the user preference and stored in the HDD 8 as bibliographic information together with the image data. With such provision, the image data may be stored in the HDD 8 while the image is output. In this case, when the image is to be output again, the user can freely select whether to output the image by use of a color/monochrome determination with respect to this second output. Printing can then be performed according to this selection.

After this, the stored image data may be output to a paper sheet. In this case, the stored image data is present in the HDD 8, and is transferred to the image processing unit 3 via the memory 7 and the image-data-expansion-bus control unit 6. Since outputting to a paper sheet is intended in this case, the image processing unit 3 performs image processing that converts the characteristics having a device-independent format into the characteristics conforming to the image writing unit 4 (step S4). Thereafter, the image writing unit 4 outputs to a paper sheet (step S6) after temporarily utilizing the memory 7 and the HDD 8 according to need (steps S5).

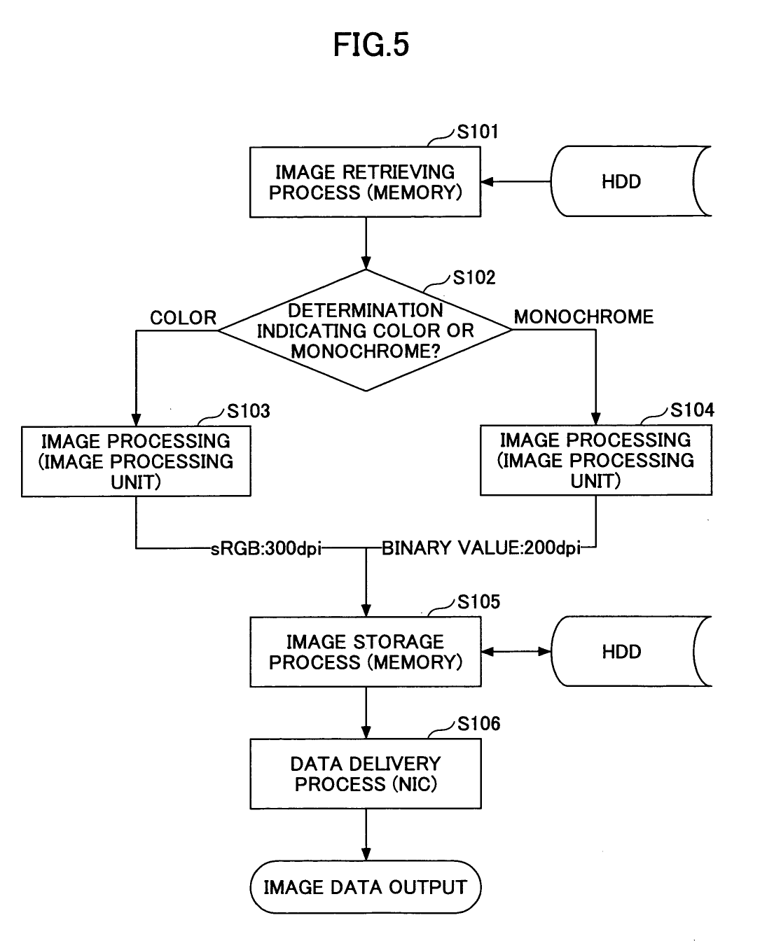

FIG. 5 is a drawing showing an example of image data delivery. That is, FIG. 5 shows a flowchart of an image data delivery process by which stored image data is delivered to an eternal PC. The flow utilizes a color/monochrome determination. Here, the stored data is RGB data of 600 dpi, and is provided with the color/monochrome determination as its bibliographic information. sRGB data of 300 dpi is output for a document determined as a color document whereas monochrome binary data of 200 dpi is output for a document determined as a monochrome document.

In FIG. 5, the image data stored in the HDD 8 is temporarily retrieved to the memory 7 (step S101).

Before the image data retrieved to the memory 7 is transferred to the image processing unit 3, the bibliographic information stored together with the image data is referred to so as to check whether the document is determined as a color document or a monochrome document (step S102). If the check reveals that the document is a color document, the image data is transferred to the image processing unit 3, and the image processing unit 3 converts the image data into an sRGB image of 300 dpi. Specifically, proper processing is performed in the filtering process (step S41) described in connection with FIG. 4, thereby performing a conversion into the characteristics conforming to the display, for example. After this, a conversion is performed in the color conversion process (step S42) to convert the RGB color space of the stored image into the sRGB color space, followed by performing a resolution conversion in the resolution conversion process (step S43) to convert 600 dpi into 300 dpi. The gamma process (step S44) and halftone process (step S45) are then performed, followed by outputting the image data.

If the check in FIG. 5 reveals that the document is a monochrome document, the image processing unit 3 operates such as to optimize output data for monochrome outputting. Specifically, proper processing is performed in the filtering process (step S41) in FIG. 4. After this, a conversion is performed in the color conversion process (step S42) to convert the RGB color space of the stored image into a monochrome gray scale. After this, a resolution conversion from 600 dpi into 200 dpi is performed in the resolution conversion process (step S43). The gamma process (step S44) is then performed, followed by the halftone process (step S45) that performs conversion into a monochrome binary image. The binarizing conversion in this case may involve simple binarization based on the comparison of data with a given threshold value, or may involve binarization that utilizes the error diffusion method. Through such binarization, a monochrome binary image of 200 dpi is output. In this manner, not only the color conversion but also other processes responsive to the determinations made on the document can be performed to provide a desired image format, including the outputting of an image of a different resolution between a color image and a monochrome image and the performing of binarization only with respect to a monochrome image.

Turning back to FIG. 5 again, the image data processed by the image processing unit 3 is temporarily stored in the memory 7 and in the HDD 8 according to need (step S105), and is then transferred from the external I/F control unit 9 and the NIC 10 to the external PC 13 via a network (step S106).

In the following, a description will be given of the process of displaying a stored image on display such as on the operating unit when image data scanned by the image scan unit 1 is stored in the memory device such as the HDD 8.

If the color space of the stored image data is a standard image space such as the AdobeRGB, the best image quality is obtained when the image space is converted into the space conforming to the characteristics of the display such as the operating unit, e.g., into the sRGB space if the display conforms to the sRGB space. The conversion in this case is performed by the image processing unit 3 as previously described. There may be situations in which it suffices to recognize a stored image only roughly as in the case in which a preview is contemplated, so that the image quality does not matter under the contemplated situations. In such a case, the stored image data may be presented as it is without any change. With this provision, processing by the image processing unit 3 can be omitted.

If it is desired to present an image based on the color/monochrome determination, the image data as it is may be used as described above in the case of a color document. In the case of a monochrome document, however, the color data needs to be converted into monochrome data. Such conversion requires image processing. However, since the image quality is not an issue in this case, a simplified conversion into a gray scale serves its purpose. The simplified conversion into a gray scale may use only the G signal among the RGB signals, and displays the G signal as the gray-scale output signal directly on display such as on the operating unit. This configuration makes it possible to easily present the color/monochrome determination on display screen for the check purpose.

As described above, the present invention can both make a determination and obtain the image data of a document through a single scan, and can apply optimum image processing based on the determination.

In particular, the determination as to whether the document is a color document or a monochrome document is temporarily stored in memory, and is then used for image processing, thereby achieving optimum image processing for both a color document and a monochrome document. In the present invention that can apply image processing on a stored image after the temporal storing of the image, there is no need to perform a scan dedicated for the purpose of making a color/monochrome determination, so that all the operation can be completed only with a single image scan. Further, the color/monochrome determination that is stored together with image data stored as standard data is used to perform optimum image processing depending on whether the output is color or monochrome. Moreover, it is possible to perform processes matching user preference by selectively setting the output processes according to the determination.

Also, if it is desired to display image data in a simplified manner according to the determination as in the case of preview presentation, the G signal that is one of the channels of the color signals may be used for the presentation of an image in the case of a monochrome determination. This configuration simplifies the conversion process, thereby helping to increase the processing speed.

Embodiments of the present invention have been described heretofore for the purpose of illustration. The present invention is not limited to these embodiments, but various variations and modifications may be made without departing from the scope of the present invention. The present invention should not be interpreted as being limited to the embodiments that are described in the specification and illustrated in the drawings.

The present application is based on Japanese priority application No. 2005-303291 filed on Oct. 18, 2005, with the Japanese Patent Office, the entire contents of which are hereby incorporated by reference.

What is claimed is:

1. An image processing apparatus, comprising:
an image scan unit configured to scan a document to produce electronic image data;
a check unit configured to make determination as to whether the document is a color document or a monochrome document based on the image data scanned by the image scan unit;
a scan image correction unit configured to correct the image data scanned by the image scan unit such that the image data has predetermined data characteristics;
a memory unit configured to store the image data corrected by the scan image correction unit; and
an image processing unit configured to perform image processing on the image data stored in the memory unit in response to the determination made by the check unit and characteristics required for outputting of the image data.

2. The image processing apparatus as claimed in claim 1, wherein the determination is simultaneously stored together with the image data corrected by the scan image correction unit when the image data is stored in the memory unit.

3. The image processing apparatus as claimed in claim 1, wherein the image processing unit outputs an image that varies depending on the determination.

4. The image processing apparatus as claimed in claim 3, wherein the image processing unit is configured to change a resolution of the output image in response to the determination.

5. The image processing apparatus as claimed in claim 3, wherein the image processing unit is configured to change a number of gray-scale levels of the output image in response to the determination.

6. The image processing apparatus as claimed in claim 3, wherein the image data includes RGB data, and the G data alone is used to display an image based on the image data stored in the memory unit if the determination indicates that the document is a monochrome document.

7. A method for image processing, comprising:
an image scan step of scanning a document to produce electronic image data;
a check step of making determination as to whether the document is a color document or a monochrome document based on the image data scanned by the image scan step;
a scan image correction step of correcting the image data scanned by the image scan step such that the image data has predetermined data characteristics;
a storing step of storing the image data corrected by the scan image correction step; and
an image processing step of performing image processing on the image data stored by the storing step in response to the determination made by the check step and characteristics required for outputting of the image data.
